(19) United States
(12) Patent Application Publication
(10) Pub. No.: US 2017/0108294 A1
(43) Pub. Date: Apr. 20, 2017

(54) HEAT EXCHANGER COMPRISING AN EXCHANGE BUNDLE EQUIPPED WITH MEANS FOR IMPROVING ATTACHMENT OF SAID EXCHANGE BUNDLE TO THE WALLS OF A HOUSING

(71) Applicant: Valeo Systemes Thermiques, Le Mesnil Saint Denis (FR)

(72) Inventor: Benjamin FERLAY, Cernay La Ville (FR)

(73) Assignee: VALEO SYSTEMES THERMIQUES, Le Mesnil Saint Denis (FR)

(21) Appl. No.: 15/301,610

(22) PCT Filed: Apr. 3, 2015
(86) PCT No.: PCT/EP2015/000723

§ 371 Date: Oct. 3, 2016

(30) Foreign Application Priority Data
Apr. 3, 2014 (FR) 1452976

(51) Int. Cl. F28F 9/26; F02M 31/20; F02B 29/04; F28D 9/00; F28F 9/00

(52) U.S. Cl. CPC F28F 9/26; F28D 9/0006; F28F 9/001; F02B 29/0462; F02M 31/20; F28D 2021/0082

(57) ABSTRACT

The invention relates to a heat exchanger comprising a housing suitable for enclosing a heat exchange bundle (40), said housing having an opening for receiving said heat exchange bundle (40) inside said housing, said heat exchange bundle (40) comprising a first extremity designed to plug the opening of the housing when the heat exchange bundle (40) is inserted into said housing (30). According to the invention, a first element is provided on the second extremity (80) of the heat exchange bundle (40) opposite said first extremity or on the lower wall (50) of the housing and is provided with at least one projecting rim (70) and a second element is provided on said second extremity of the heat exchange bundle (40) or on said lower wall (50) of the housing (30) and is provided with a groove (51) designed to receive and attach said at least one projecting rim (70), and said at least one projecting rim (70) and said at least one groove (51) are designed to attach the at least one projecting rim (70) in the at least one groove (51) using an adhesive. Application in the automobile field.

### DOMAIN OF THE INVENTION

The present invention relates to a heat exchanger, for example a heat exchanger intended for a motor vehicle. More specifically, the invention relates to a heat exchanger enabling exchange between a first fluid and a second fluid, in which the first fluid is for example a fluid such as air and the second fluid is for example a liquid fluid such as water. The heat exchanger according to the present invention is in particular designed to be used to cool charge air.

### PRIOR ART

Nowadays, combustion engines in motor vehicles are commonly fed with compressed air to improve the performance of said engines. This compressed air is often referred to as “charge air”. The compressed air is obtained using a compressor driven by exhaust gases. Consequently, compression of the air results in the compressed air being heated. The compressed air needs to be cooled before being delivered to the engine in order to lower the temperature of said compressed air before it is delivered to a cylinder of the engine.

In order to cool the compressed air, it is known to use a heat exchanger comprising a heat exchange bundle formed by an assembly of plates that are positioned on top of one another and that together form a conduit designed to guide a first fluid such as a liquid from an inlet to an outlet. In order to improve the heat exchange, the plate assembly also incorporates corrugated inserts.

The heat exchange bundle is positioned inside a casing or housing. This housing is provided with an inlet and an outlet for the second fluid to be cooled, such as air, and is designed to guide the second fluid from an inlet to an outlet. The housing acts as a collector box enclosing said heat exchange bundle and enabling the intake and regulation of the charge air. Such a housing is for example molded using a material such as aluminum or plastic.

In practice, the walls of the housing are relatively thin and relatively flexible. As such, when the housing is in use, the volume of said housing may increase as a function of the increase in pressure and in temperature inside the housing.

In the prior art, the housing of a heat exchanger is provided with an opening enabling the heat exchange bundle to be inserted into the housing. In practice, the housing is essentially a box with five walls. The sixth wall is removed to enable the heat exchange bundle to be inserted into the housing by moving said bundle towards the inside of the housing in an insertion direction. When the heat exchange bundle is in place, the sixth wall of the housing is formed by a cover to which a first extremity of the heat exchange bundle is attached.

For this type of application, the cover enables the plate assembly to be connected to the corrugated inserts of the heat exchanger and enables the assembly to be attached to said cover. The cover is provided with conduits enabling the fluid such as a liquid to enter the inside of the heat exchanger and to leave the heat exchanger. The cover attached to the heat exchange bundle performs the function of closing the opening used to insert the heat exchanger. Thus, the heat exchange bundle is firstly enclosed or surrounded by the walls of the housing, and secondly surrounded by the cover.

In the usage position of same, the cover to which the heat exchange bundle is attached is, as a general rule, positioned substantially horizontally above said heat exchange bundle. In other words, the heat exchange bundle is suspended from the cover.

The heat exchangers known in the prior art have numerous drawbacks. Firstly, the connection between the housing and the cover is fragile and is required to withstand the high pressures and high temperatures occurring inside the heat exchanger. Furthermore, during normal usage of the heat exchanger, the walls of the housing may deform under the pressure of the hot air present inside said heat exchanger. This deformation, which is constant during use of the heat exchanger, may cause the premature wear of the material used to manufacture the housing. This may adversely affect the reliability of the housing.

Furthermore, since the heat exchange bundle is suspended from the cover, the heat exchange bundle may be subject to pendular movements caused by the vibrations resulting from operation of the engine of the vehicle in which the heat exchanger is used. The repetition of such pendular movements, in particular combined with a resonance effect, may have a negative impact on the reliability of the heat exchanger.

### PURPOSE OF THE INVENTION

The heat exchanger according to the present invention is intended to address the drawbacks of the heat exchangers disclosed in the prior art by proposing a new means for attaching a heat exchange bundle inside the housing of a heat exchanger.

For this purpose, the present invention relates to a heat exchanger comprising a housing suitable for enclosing a heat exchange bundle, said housing having an opening for receiving said heat exchange bundle inside said housing, said heat exchange bundle comprising a first extremity designed to plug the opening of the housing when the heat exchange bundle is inserted into said housing, characterized in that a first element is provided on the second extremity of the heat exchange bundle opposite said first extremity or on the lower wall of the housing and is provided with at least one projecting rim, in that a second element is provided on said second extremity of the heat exchange bundle or on said lower wall of the housing is provided with a groove designed to receive and attach said at least one projecting rim inside same in order to limit the mobility of the second extremity of the heat exchange bundle in relation to said lower wall of the housing, and in that said at least one projecting rim and said at least one are designed to attach the at least one projecting rim inside the at least one groove using an adhesive.

The projecting rim or protuberance prevents the second extremity of the heat exchange bundle from moving in relation to the walls of the housing, thereby limiting the pendular movement of the heat exchanger. The projecting rim may be attached to the lower extremity of the heat exchange bundle. The projecting rim may also be attached to the lower wall of the housing. The projecting rim is held or attached in place inside a groove. If the projecting rim is attached to the lower wall of the housing, the groove is located at the lower extremity of the heat exchange bundle. If the projecting rim is attached to the lower extremity of the heat exchange bundle, the groove is located on the lower wall of the housing. The projecting rim is held inside said groove using attachment means such as an adhesive. In other words, the connection between the housing and the cover is made more secure by the absence of any pendular movement of the heat exchange bundle in relation to the housing as a result of the vibrations caused by operation of the engine of the vehicle in which the heat exchanger is being used.

According to a specific embodiment of the invention, during assembly of the heat exchanger, the heat exchange bundle is inserted into the housing in an insertion direction such that the projecting rim and the groove extend in a direction substantially perpendicular to said insertion direction.

According to a specific embodiment of the invention, the adhesive is a single-component adhesive.

According to a specific embodiment of the invention, the adhesive is a two-component adhesive.

According to a specific embodiment of the invention, said at least one rim is an anchoring means and, in projection, has a substantially L-shaped profile.

The projecting edge, which is attached using an adhesive and has a substantially L-shaped profile, has one curved extremity forming the short arm of the “L”. The curved extremity improves attachment of the projecting rim with the adhesive inside the groove. The L-shape of the projecting rim improves the attachment compared to the attachment of an I-shaped projecting rim.

According to a specific embodiment of the invention, the groove is in the form of a profile and is formed at the second lower extremity of the heat exchange bundle using a brazing method.

### SHORT DESCRIPTION OF THE DRAWINGS

The objectives, purpose and characteristics of the present invention, as well as the advantages thereof, are set out more clearly in the following description of the preferred embodiments of a heat exchanger according to the invention, made with reference to the drawings, in which:

FIG. 1 is a cross-sectional view of a heat exchanger inside a housing according to a first embodiment of the present invention, given by way of example,

FIG. 2 is a detailed view of the attachment of the heat exchange bundle to the walls of the housing of the heat exchanger in FIG. 2, given by way of example,

FIG. 3 shows a heat exchanger inside a housing according to a second embodiment of the present invention, given by way of example,

FIG. 4 is a cross-sectional view of a heat exchanger inside a housing according to a third embodiment of the present invention, given by way of example, and

FIG. 5 is a detailed view of the attachment of a heat exchange bundle to the walls of the housing of a heat exchanger according to a fourth embodiment of the present invention, given by way of example.

### DETAILED DESCRIPTION OF THE EMBODIMENTS

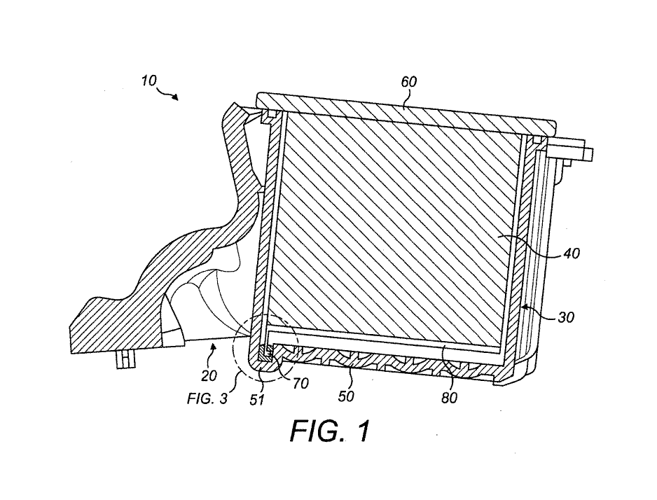

FIG. 1 is a cross-sectional view of a heat exchanger 10.

The heat exchanger 10 as shown in FIG. 1 is particularly designed for use in the automobile industry to cool the charge air in a thermal engine. The heat exchanger 10 enables the charge air to be cooled by heat exchange with a first fluid, such as the outside air, or a liquid such as the cooling water of an engine, thereby forming an air/air or liquid/air exchanger.

Firstly, the heat exchanger 10 has an intake manifold 20, commonly referred to by the person skilled in the art using that English term (“intake manifold”). The intake manifold 20 is attached to the cylinder head of the combustion chamber of the engine (not shown), i.e. at the entrance to the cylinder. Depending on the speed of the engine, the air may be cooled totally, partially or not at all. The intake manifold 20 is connected to a housing 30. The housing 30 forms an envelope to surround a heat exchange bundle 40 positioned inside said housing 30. The housing 30 has an inlet and an outlet for a first gaseous fluid and is designed to guide said first fluid from an inlet to an outlet.

According to the present invention, the heat exchange bundle 40 is positioned inside the housing 30.

The heat exchange bundle 40 is formed, for example, by an assembly of plates positioned on top of one another, together forming a conduit enabling a second liquid fluid, which is used to cool the first gaseous fluid, to be guided from an inlet to an outlet. In order to improve the heat exchange, the plate assembly also incorporates corrugated inserts.

According to a known operating mode, a first fluid, such as air, passes through the heat exchange bundle 40 and a second fluid, such as the water in the cooling circuit, flows inside the heat exchange bundle 40, thereby enabling the air to be cooled.

The heat exchange bundle 40 is formed by an assembly of stamped plates, or “half blades”. However, the invention also relates to other types of bundle, and in particular bundles comprising pipes and fins. The heat exchange bundle 40, as shown in FIG. 1, is for example formed by a stack of stamped identical plates arranged in pairs.

As shown in FIG. 1, the upper portion of the heat exchange bundle 40 is attached to a closing element such as a plate or a cover 60. The cover 60 performs several functions. One of the functions involves providing an inlet and an outlet for the liquid coolant using pipes arranged on the cover 60. Furthermore, the cover 60 acts as the closing element for the housing 30. Thus, when the heat exchanger 10 is assembled, the heat exchange bundle 40 is enveloped firstly by the walls formed by the housing 30 and secondly by the cover 60.

The features of the heat exchanger 10 as shown in FIG. 1 are such that the heat exchange bundle 40 is suspended from the cover 60. This means that, during normal usage according to the prior art, under the effect of vibrations caused by operation of the motor vehicle to which the heat exchanger 10 is connected, the heat exchange bundle 40 may be subject to pendular movements and may move in relation to the inside of the housing 30. In the prior art, this pendulum movement weakens the attachment between the cover 60 and the housing 30.

Furthermore, in the prior art, since the lower wall of the housing 30 is not attached to the lower portions of the heat exchange bundle, the walls of the housing 30, and in particular the lower wall, may be deformed under the pressure of the hot air present inside the heat exchanger. This deformation, which is constant during use of the heat exchanger, may cause premature wear of the material used to manufacture the housing 30.

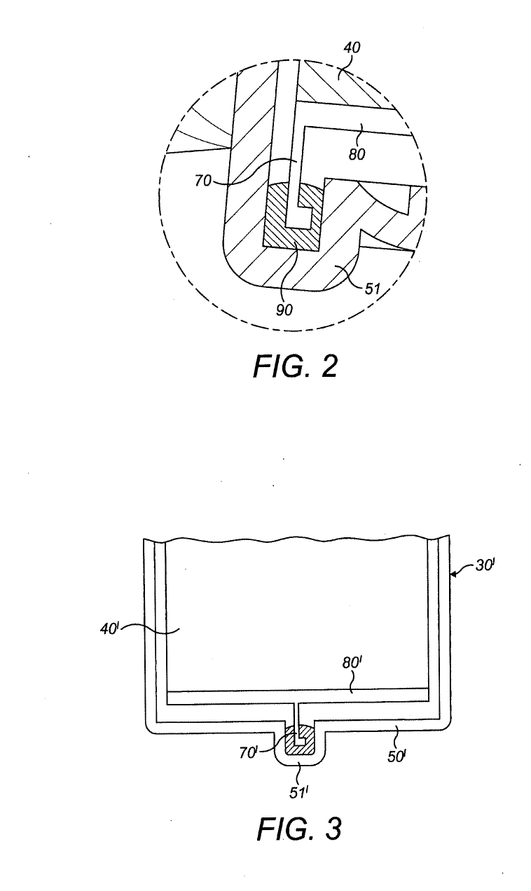

Unlike a heat exchanger in the prior art, the lower wall 50 of the housing 30 is provided with a groove or a channel 51, as shown in FIG. 1. The lower portion of the groove 51 forms a specific volume. The plate 80 forming the lower portion of the heat exchange bundle 40 includes a projecting rim or a protuberance 70. The specific volume of the groove 51 is designed to receive the protuberance 70. The attachment of the protuberance 70 inside the groove 51 is shown in greater detail in FIG. 2.

FIG. 2 shows the lower portion of the heat exchange bundle 40 formed by the plate 80. The extremity of the plate 80 has anchoring means provided in this case in the form of an L-shaped protuberance 70. The L-shaped protuberance is seated inside the volume formed by the groove 51. Other embodiments that have not been shown propose T-shaped or F-shaped anchoring means.

The inside of the groove 51 is at least partially filled with attachment means 90, such as an adhesive. Once the attachment means 90 has solidified, the protuberance 70 is held or attached inside the groove 51. Thus, the lower portion of the heat exchange bundle 40 is attached to the wall 50 of the housing 30. This attachment helps to prevent the pendular movements that could occur as a result of the vibrations caused by operation of the engine of the motor vehicle in which the heat exchanger 10 is being used. Furthermore, the wall 50 cannot be deformed or moved in relation to the cover 60 as a result of the pressure of the hot air present inside the heat exchanger 10.

In the prior art, during assembly of a heat exchanger, the housing is, as a general rule, installed in a vertical position, i.e. with the opening oriented upwards. Subsequently, the assembly formed by the cover and the heat exchange bundle is inserted vertically into the housing until the cover comes into contact with said housing.

Unlike the prior art, according to the embodiment of the present invention as shown in FIGS. 1 and 2, the method for assembling a heat exchanger 10 includes a step before insertion of the assembly formed by the cover 60 and the heat exchange bundle 40 in order to fill the groove 51 with attachment means, such as an adhesive. The adhesive may be a single-component adhesive. The air and the moisture present inside the heat exchanger 10 following assembly of same then hardens the adhesive.

Alternatively, a two-component adhesive may be used, i.e. the hardening process of the adhesive is initiated by the presence of a first and of a second component together forming said adhesive 90.

In order to facilitate assembly, when inserted into the groove 51, the attachment means 90 has a relatively high viscosity. This means that the attachment means 90 is pasty and not liquid. The consistency of the attachment means 90 is therefore sufficiently flexible to receive the protuberance 70 and sufficiently viscous to prevent movement of the protuberance 70, in particular during movement of the housing 30 on a conveyor belt during assembly of the heat exchanger 10, for example

As shown in FIG. 2, the dimensions of the zone inside the groove 51 are relatively large in relation to the dimensions of the protuberance 70. Thus, this size difference facilitates the insertion of the heat exchanger bundle 40 into the housing 30 during assembly of same. Furthermore, this size difference makes it possible to assemble the components of said heat exchanger 10 with a relative tolerance regarding the dimensions of said components, without thereby compromising the assembly of said heat exchanger 10.

The heat exchangers shown in FIGS. 1, 2 and 3 are relatively inexpensive to produce. The plate 80 forming the lower extremity of the heat exchange bundle 40 is, as a general rule, obtained using an extrusion method. Modifying the extrusion method to obtain a plate 80 that has at least one protuberance 70 at the extremity of same does not generate any additional costs. As a general rule, the wall of the housing 30 is made from a plastic material. Thus, the additional formation of the groove 51 only slightly increases the production cost for such a housing 30. In other words, the solution as described in FIGS. 1, 2 and 3 does not require additional separate parts when manufacturing a heat exchanger 10. The attachment means 90 that may be used for attachment are also relatively inexpensive.

FIG. 3 shows a second embodiment of the heat exchanger according to the present invention. According to FIG. 3, the wall 50′ of the housing 30′ is provided with a groove or channel 51′ that is positioned centrally and designed to receive a protuberance 70′. The protuberance 70′ is attached to the plate 90′ forming the lower portion of the heat exchange bundle 40′. The attachment of the protuberance 70′ inside the groove 51′ is identical to the attachment of the protuberance 70 inside the groove 51, as shown in FIGS. 1 and 2.

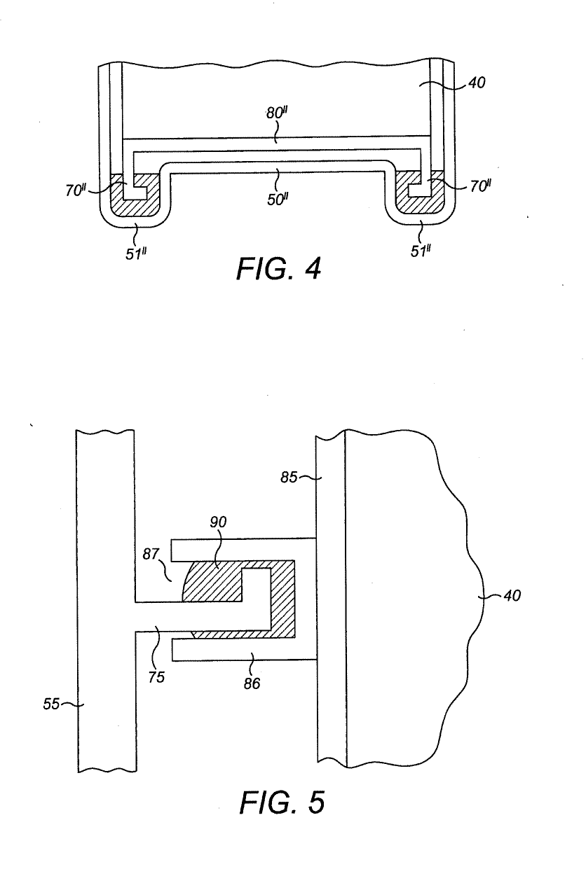

FIG. 4 shows a third embodiment of the heat exchanger according to the present invention in which the plate 80″ forming the lower portion of the heat exchange bundle 40 is provided with two protuberances 70″ at the two extremities of the plate 90″. The lower wall 50″ is provided with two grooves or channels 51″ to receive the first and second protuberances 70″ respectively.

FIG. 5 shows a fourth embodiment of the heat exchanger according to the present invention. According to FIG. 5, the lower plate of a heat exchange bundle 40 is provided with a plate 85 on the lower side of same. The plate 85 is itself provided with an element 86 forming a channel with an opening 87 oriented downwards in order to receive a protuberance 75 within same, said protuberance being attached to the inside of a lower wall 55 of a housing 30. The attachment of the protuberance 75 inside the channel 86 is comparable to the attachment of the protuberances 70, 70′ and 70″. An attachment means 90 having a relatively high viscosity is present inside the channel 86. When said attachment means 90 is inserted into the channel 86, same adheres to the walls of the channel 86 even though the opening 87 of the channel 86 is oriented downwards. This means that the heat exchanger according to the fourth embodiment of the invention may be assembled in the same manner as in embodiments 1, 2 and 3 according to the present invention. A heat exchanger 40 and a cover 60 may be combined vertically in order to enable the insertion of the protuberance 75 inside the channel 66, same being attached using the attachment means 90 inside the channel 86.

1. A heat exchanger comprising:
a housing for enclosing a heat exchange bundle, said housing having an opening for receiving said heat exchange bundle inside said housing,
said heat exchange bundle comprising a first extremity to plug the opening of the housing when the heat exchange bundle is inserted into said housing, wherein
a first element is provided on the second extremity of the heat exchange bundle opposite said first extremity or on the lower wall of the housing and is provided with at least one projecting rim,
a second element is provided on said second extremity of the heat exchange bundle or on said lower wall of the housing and is provided with a groove designed to receive and attach said at least one projecting rim, and
said at least one projecting rim and said at least one groove are configured to attach the at least one projecting rim in the at least one groove using an adhesive.

2. The heat exchanger as claimed in claim 1, wherein the heat exchange bundle, during assembly of the heat exchanger, is inserted into the housing in an insertion direction, the projecting rim and the groove extending in a direction substantially perpendicular to said insertion direction.

3. The heat exchanger as claimed in claim 1, wherein the adhesive is a single-component adhesive.

4. The heat exchanger as claimed in claim 1, wherein the attachment means is a two-component adhesive.

5. The heat exchanger as claimed in claim 1, wherein the at least one projecting rim is an anchoring means and has an essentially L-shaped cross section.

6. The heat exchanger as claimed in claim 1, wherein the groove is in the form of a profile and is connected to the second extremity of the heat exchange bundle, and wherein said profile is connected to the heat exchange bundle using a brazing method.
